(19) United States
(12) Patent Application Publication
(10) Pub. No.: US 2026/0365297 A1
(43) Pub. Date: Nov. 19, 2026

(54) VESSEL STEERING SYSTEM AND VESSEL STEERING CONTROL METHOD

(71) Applicant: YAMAHA HATSUDOKI KABUSHIKI KAISHA, Iwata-shi (JP)

(72) Inventor: Kazumichi YOSHIDA, Shizuoka (JP)

(21) Appl. No.: 19/678,290

(22) Filed: May 15, 2026

(30) Foreign Application Priority Data
May 16, 2025 (JP) 2025-082846

(51) Int. Cl. B63H 25/04; B63B 79/15; B63B 79/40; G08G 3/02

(52) U.S. Cl. CPC B63H 25/04; B63B 79/15; B63B 79/40; G08G 3/02

(57) ABSTRACT

A vessel steering system and a steering control method for marine vessels increases obstacle detection accuracy while reducing the computational load of obstacle detection. The vessel steering system includes a sensor to acquire location data of an object, and a camera to capture surroundings of the marine vessel. An obstacle around the marine vessel is detected based on a bounding box created from an image generated by the camera and based on a plurality of pieces of location data acquired by the sensor.

### CROSS REFERENCE TO RELATED APPLICATIONS

This application claims the benefit of priority to Japanese Patent Application No. 2025-082846 filed on May 16, 2025. The entire contents of this application are hereby incorporated herein by reference.

### BACKGROUND OF THE INVENTION

### 1. Field of the Invention

The present invention relates to vessel steering systems and vessel steering control methods.

### 2. Description of the Related Art

There is a known technique for detecting an obstacle on the sea using a distance measuring sensor such as a millimeter wave radar or a LiDAR sensor. Such a distance measuring sensor measures the location of an obstacle on the sea, and acquires location data. When a distance measuring sensor is used for obstacle detection, the distance measuring sensor may sometimes acquire noise data such as location data indicating a location at which no obstacle actually exists. Such noise data is a factor of degradation in obstacle detection accuracy, and therefore, is preferably removed as much as possible. To counter this, a system for increasing obstacle detection accuracy has been proposed (see Japanese Laid-Open Patent Publication (Kokai) No. 2021-197043, for example). In this system, the existence reliability of an obstacle is calculated, for example, based on location data and type data of the object measured by a radar or the like and on a result of estimation of the obstacle's location and type obtained by inputting an image captured by a camera to a trained model.

However, the above-described technology relies on a computationally expensive process, such as an estimation process using a trained model, and therefore, there is still room for improvement in reducing the computational load of obstacle detection.

### SUMMARY OF THE INVENTION

Example embodiments of the present invention provide vessel steering systems and vessel steering control methods that are each able to increase obstacle detection accuracy while reducing the computational load of obstacle detection.

According to an example embodiment of the present invention, a vessel steering system includes a sensor to acquire location data of an object, and a camera to capture surroundings of the marine vessel. The vessel steering system further includes a controller configured or programmed to detect an obstacle around the marine vessel based on a bounding box created from an image generated by the camera and based on a plurality of pieces of location data acquired by the sensor.

According to another example embodiment of the present invention, a steering control method is provided for a marine vessel including a camera and a sensor to acquire location data of an object. The steering control method includes detecting an obstacle around the marine vessel based on a bounding box created from an image generated by the camera and based on a plurality of pieces of location data acquired by the sensor.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view of an example of a marine vessel including a vessel steering system.

FIG. 2 is a perspective view of relevant portions of a cockpit of the marine vessel illustrated in FIG. 1.

FIG. 3 is a block diagram schematically illustrating an example configuration of a vessel steering system included in the marine vessel illustrated in FIG. 1.

FIG. 4 is a flowchart illustrating the procedure of an example of an obstacle detection process to be executed by the vessel steering system illustrated in FIG. 3.

FIGS. 5A to 5C are diagrams each illustrating an example of an image to be used in the obstacle detection process in FIG. 4.

FIG. 6 is a diagram for explaining positioning correction in step S45 in FIG. 4.

### DETAILED DESCRIPTION OF THE EXAMPLE EMBODIMENTS

Hereinafter, example embodiments of the present invention will be described with reference to the drawings.

With a vessel steering system and a steering control method according to example embodiments, a bounding box to be used to remove noise data is created from an image generated by a camera, and an obstacle is detected based on the bounding box and a plurality of pieces of location data acquired by a sensor. This avoids the necessity to perform an estimation process, which uses a trained model and thus is computationally expensive, in order to increase obstacle detection accuracy. Thus, it is possible to increase obstacle detection accuracy while reducing the computational load of obstacle detection.

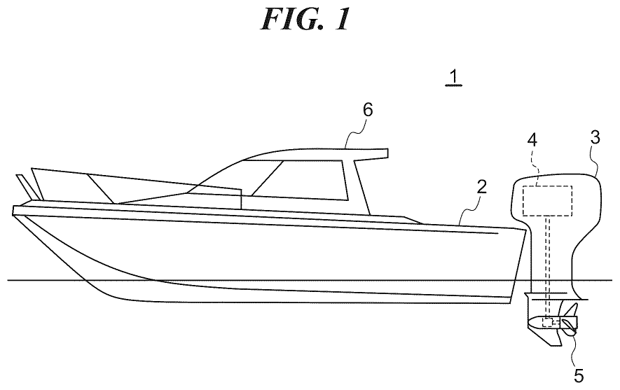

FIG. 1 is a side view of an example of a marine vessel including a vessel steering system according to an example embodiment of the present invention. A marine vessel 1 includes a hull 2 and two outboard motors 3 attached to the hull 2. Each of the outboard motors 3 includes an engine 4 and a propeller 5, and generates a thrust force by the propeller 5 rotated by a drive force of the engine 4. Note that the number of the outboard motors 3 on the marine vessel 1 is not necessarily two. Instead, the marine vessel 1 may include only one outboard motor 3, or the marine vessel 1 may include three or more outboard motors 3. Alternatively, the marine vessel 1 may include an electric outboard motor, an inboard motor, or an inboard/outboard motor as a marine propulsion device in place of the outboard motors 3. Further, the marine vessel 1 may be a jet propulsion boat.

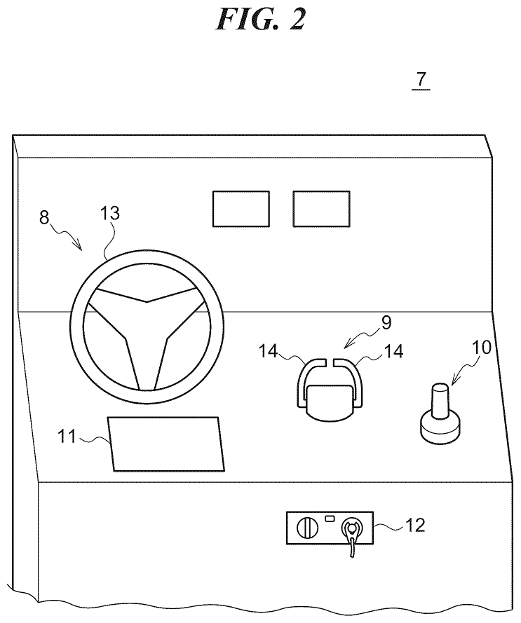

In the marine vessel 1, the hull 2 houses a cabin 6, and a cockpit 7 is disposed in the cabin 6. FIG. 2 is a perspective view of relevant portions of the cockpit 7. A steering mechanism 8, a remote controller 9, a joystick 10, a multi-functional display (MFD) 11, and a main switch 12 are disposed in the cockpit 7.

The steering mechanism 8 is a device for a vessel operator to determine the course of the marine vessel 1. The steering mechanism 8 includes a turnable steering wheel 13. When a vessel operator turns the steering wheel 13 left or right, this controls the motor steering mechanisms of the outboard motors 3, each including an actuator and a bracket, to change the orientations of the outboard motors 3.

The remote controller 9 includes two levers 14 corresponding to the respective outboard motors 3. A vessel operator operating one of the levers 14 is able to switch the direction in which a thrust force generated by the corresponding outboard motor 3 acts between forward and backward, and to control the output of the corresponding outboard motor 3 to adjust the velocity of the marine vessel 1. For example, when a vessel operator moves one of the levers 14 forward, that is, to a forward position to advance the marine vessel 1, the corresponding outboard motor 3 generates a thrust force in the forward direction. When a vessel operator moves one of the levers 14 backward, that is, to a reverse position to move the marine vessel 1 backward, the corresponding outboard motor 3 generates a thrust force in the backward direction. Further, when a vessel operator moves one of the levers 14 to a neutral position located between the forward position and the reverse position, the connection between the engine 4 and the propeller 5 is disconnected by a clutch in the corresponding outboard motor 3, and the corresponding outboard motor 3 does not apply a thrust force to the marine vessel 1.

The joystick 10 is a rod-shaped operating component that is tiltable forward, backward, leftward, and rightward and to pivotable about an axis. A vessel operator operating the joystick 10 is able to move the marine vessel 1 along a course corresponding to the tilting direction of the joystick 10 with a thrust force corresponding to the amount of tilt of the joystick 10.

The MFD 11 includes, for example, a color LCD display, and functions as a display to display various types of information. The MFD 11 also functions as a touch panel to receive an input from a vessel operator.

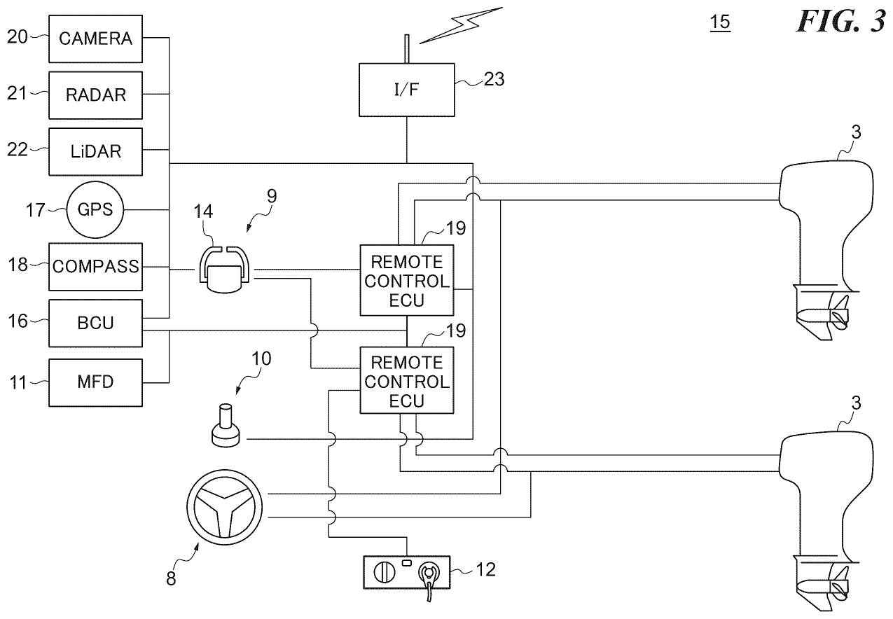

FIG. 3 is a block diagram schematically illustrating an example configuration of a vessel steering system 15 included in the marine vessel 1 illustrated in FIG. 1. In FIG. 3, the vessel steering system 15 includes the outboard motors 3, the steering mechanism 8, the remote controller 9, the joystick 10, the MFD 11, the main switch 12, a boat control unit (BCU) 16 (a controller), a GPS 17, a compass 18, remote control engine control units (remote control ECUs) 19, a camera 20, a radar (RADAR) 21 (a sensor), a lidar (LiDAR) 22 (a sensor), and a communication interface (I/F) 23. The components of the vessel steering system 15 are communicably connected to one another.

The steering mechanism 8 is configured to transmit, to the remote control ECUs 19, steering angle signals corresponding to a turning operation performed on the steering wheel 13 by a vessel operator. The remote controller 9 is configured to transmit, to the remote control ECUs 19, signals (e.g., forward or reverse movement signals) corresponding to operations performed on the levers 14 by a vessel operator. The joystick 10 is configured to transmit, to the remote control ECUs 19, signals corresponding to the direction of tilt and the amount of tilt resulting from an operation performed on the joystick 10 by a vessel operator. The MFD 11 is configured to transmit, to the BCU 16 and the remote control ECUs 19, signals corresponding to an input received via the MFD 11 from a vessel operator.

The main switch 12 is configured to receive an instruction to turn on or start the outboard motors 3, and then transmit signals corresponding to the received instruction to the BCU 16 and the remote control ECUs 19. The BCU 16 is configured to monitor situations of the marine vessel 1 based on signals transmitted from the components of the vessel steering system 15, determine the magnitudes of the thrust forces to be generated by the outboard motors 3 and the acting directions in which the thrust forces are to be directed, and then transmit control signals to the remote control ECUs 19.

The GPS 17 is configured to monitor the current location of the marine vessel 1, and transmit to the BCU 16 the current location of the marine vessel 1 as location information. The compass 18 is configured to monitor the heading of the marine vessel 1 (the direction in which the bow of the marine vessel 1 is pointed), and transmit the heading of the marine vessel 1 to the BCU 16.

The camera 20 is configured to capture optical images to monitor the surroundings of the marine vessel 1. In the present example embodiment, a plurality of cameras 20 are attached to different locations on the outer periphery of the marine vessel 1, and the entire periphery of the marine vessel 1 is captured with the plurality of cameras 20. Since it is difficult to judge distances on the sea, the plurality of cameras 20 may be attached to such locations that a portion of the marine vessel 1, such as the bow or the stern, appears in captured images, in order to facilitate understanding of a sense of depth in the captured images. Note that, in the present example embodiment, an example configuration in which the plurality of cameras 20 are attached to the outer periphery of the marine vessel 1 is described. However, the attachment locations of the plurality of cameras 20 are not limited to the outer periphery of the marine vessel 1, as long as they are such locations that the entire periphery of the marine vessel 1 can be captured, and a portion of the marine vessel 1 appears in the captured images. Each of the cameras 20 is configured to transmit the captured images to the BCU 16.

The radar 21 is configured to acquire location data of an object detected by emitting electromagnetic waves, specifically radio waves, around the marine vessel 1. The location data acquired by the radar 21 includes, for example, information indicating the location of the detected object. The lidar 22 is configured to acquire location data of an object detected by emitting electromagnetic waves, specifically laser light, around the marine vessel 1. The lidar 22 can identify objects, and three-dimensionally measure the distances, the shapes, and the positional relationship of the objects. The location data acquired by the lidar 22 includes, for example, information indicating the location of the detected object, and height information about the object. The radar 21 and the lidar 22 are configured to transmit the acquired object location data to the BCU 16. The communication I/F 23 is configured to communicate with external servers and other devices outside the marine vessel 1, and transmit signals received from external sources to the BCU 16.

For each of the outboard motors 3, one remote control ECU 19 is provided. According to signals transmitted from the BCU 16, the remote controller 9, the joystick 10, or the like, each of the remote control ECUs 19 controls actuators for the motor steering mechanism and the shift mechanism of the corresponding outboard motor 3 and for the throttle mechanism of the engine 4 of the corresponding outboard motor 3, thus adjusting the magnitude of a thrust force to be generated by the corresponding outboard motor 3 and the direction in which the thrust force acts. Therefore, with the vessel steering system 15, a vessel operator can control the velocity and the direction of the bow of the marine vessel 1 by operating the joystick 10 or the levers 14 of the remote controller 9. Note that the shift mechanism includes a clutch, a shift fork, and a gear, and is configured to switch the direction of the thrust force between forward and backward by changing the direction of rotation of the propeller 5. The throttle mechanism of the engine 4 is configured to adjust the amount of intake air of the engine 4 to control the speed of the engine 4, thus controlling the magnitude of the thrust force.

The vessel steering system 15 is configured to detect an obstacle on the sea using a distance measuring sensor such as the radar 21 or the lidar 22. Specifically, the vessel steering system 15 uses the distance measuring sensor to measure the location of an obstacle on the sea and to acquire location data of the obstacle. In a case where the distance measuring sensor is used for obstacle detection, location data indicating a location at which any obstacle does not actually exist is sometimes acquired as noise data. Such noise data is a factor of degradation in obstacle detection accuracy, and therefore, is preferably removed as much as possible.

Therefore, in an example embodiment, obstacle detection is performed based on a bounding box created from each of images generated by the cameras 20, and based on a plurality of pieces of acquired location data.

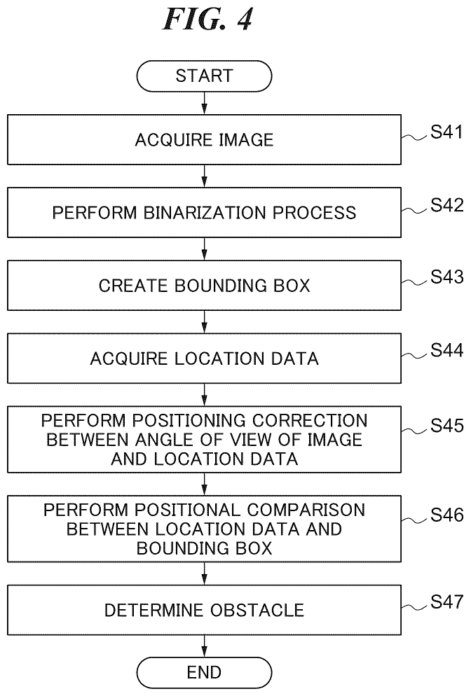

FIG. 4 is a flowchart illustrating the procedure of an example of an obstacle detection process to be executed by the vessel steering system 15 illustrated in FIG. 3. This process is performed by the BCU 16 in accordance with a program stored in a memory or a program temporarily downloaded from an external server. That is, the BCU 16 operates as an obstacle detector. Note that this process is repeatedly performed, for example, while the vessel steering system 15 is running.

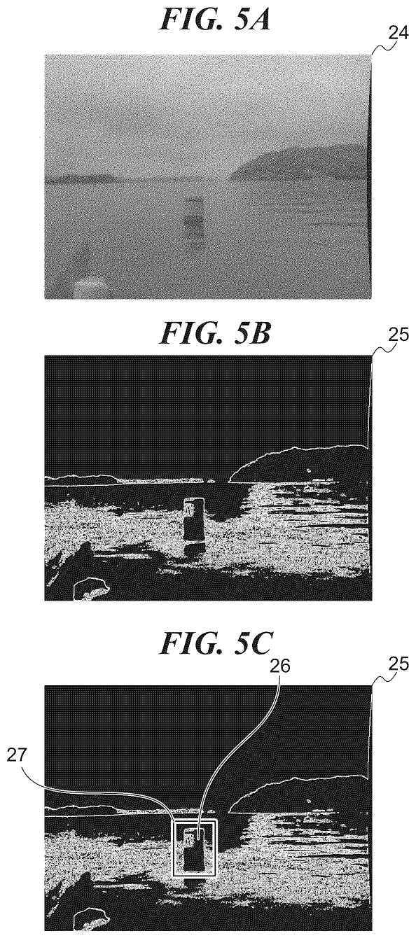

In FIG. 4, the BCU 16 first acquires an image from each of the cameras 20 (step S41). In an example embodiment, it is assumed that an image 24 in FIG. 5A is acquired from one of the cameras 20 of a situation on the sea.

Next, the BCU 16 performs a binarization process on each image acquired in step S41 (step S42). In the binarization process, the pixel value of each of the pixels of the images is compared with a preset threshold. A pixel value equal to or greater than the threshold is converted, for example, into a white pixel value, and a pixel value smaller than the threshold is converted, for example, into a black pixel value. Note that a pixel value equal to or greater than the threshold may be converted into a black pixel value, and a pixel value smaller than the threshold may be converted into a white pixel value. Furthermore, in an example embodiment, an object on the sea that hinders the vessel's navigation is regarded as an obstacle. Therefore, to facilitate detection of the object, for example, a pixel value that accentuates the sea surface may be used as the threshold in the binarization process in step S42. In step S42, when the binarization process is performed, for example, on the image 24, a binarized image 25 in FIG. 5B is obtained. In this manner, in step S42, the binarization process is performed on each image acquired in step S41 to generate a plurality of binarized images.

Next, the BCU 16 creates bounding boxes from the binarized images generated in step S42 (step S43). A bounding box is an outline or frame surrounding an object region in an image. For example, the BCU 16 performs predetermined image processing to detect an object in each of the binarized images generated in step S42, and creates a bounding box for each binarized image. Note that, for the predetermined image process, it is preferable to use a process with a relatively low computational load, such as an edge detection process or a contour detection process, as long as it is a process by which an object can be detected. In step S43, when the predetermined image process is performed on the binarized image 25, for example, a bounding box 27 surrounding an object region 26 in the binarized image 25 is created, as illustrated in FIG. 5C. In this manner, in step S43, a bounding box is created for each of the binarized images acquired in step S42.

Next, the BCU 16 acquires location data of the detected object from a distance measuring sensor attached to the marine vessel 1, such as the lidar 22 (step S44). As described above, the location data includes information indicating the location of an object detected by the lidar 22, and the height information about the object.

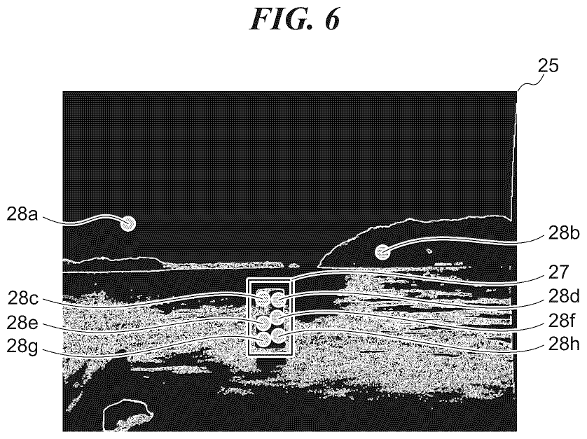

Next, the BCU 16 performs a positioning correction between the angle of view of the binarized images generated in step S42 and the location data acquired in step S44 (step S45). In the marine vessel 1, the lidar 22 is attached to a location different from the plurality of cameras 20. In step S45, the above correction is performed based on the attachment location of each of the cameras 20 and the attachment location of the lidar 22. By this correction, as illustrated in FIG. 6, for example, pieces of location data 28a to 28h are placed at corresponding locations in the binarized image 25 generated in step S42. In this manner, in an example embodiment, pieces of location data are provided at the corresponding locations on each of the plurality of binarized images generated in step S42.

Next, the BCU 16 performs a positional comparison between the bounding box and the location data in each binarized image (step S46).

Next, the BCU 16 determines an obstacle based on the result of the comparison performed in step S46 (step S47). Specifically, in each binarized image, the BCU 16 uses a subset of the location data falling within the region of the bounding box to determine an obstacle. For example, in FIG. 6, pieces of location data 28c to 28h falling within the region of the bounding box 27 are used to determine an obstacle, and the region indicated by the pieces of location data 28c to 28h is determined to be the region of an obstacle. On the other hand, in each binarized image, the BCU 16 does not use a subset of the location data not falling within the region of the bounding box to determine an obstacle. For example, in FIG. 6, pieces of location data 28a and the location data 28b that are not within the region of the bounding box 27 are determined to be noise data, and are not used to determine an obstacle. After that, this process comes to an end. Information about the obstacle detected by the above-described obstacle detection process is displayed, for example, on the MFD 11, and the vessel operator is notified of the presence of the obstacle. Alternatively, the information about the obstacle detected by the above-described obstacle detection process is used when a sea route is determined in an automatic vessel steering mode of the marine vessel 1.

According to an example embodiment, the bounding box 27 to be used to remove noise data is created from each of images generated by the plurality of cameras 20, and an obstacle is detected based on the bounding box 27 and a plurality of pieces of location data acquired by the lidar 22. This avoids the necessity to perform an estimation process, which uses a trained model and thus is computationally expensive, in order to increasing obstacle detection accuracy. Thus, it is possible to increase obstacle detection accuracy while reducing the computational load of obstacle detection. Note that the number of cameras included in the vessel steering system 15 may be one.

Also, in an example embodiment, an obstacle is detected based on a subset of the plurality of pieces of acquired location data that fall within the region of the bounding box 27. This allows an obstacle to be detected using only pieces of valid location data obtained by removing noise data from the plurality of pieces of acquired location data, and thus, obstacle detection accuracy can be increased.

Further, in an example embodiment, a positioning correction between the angle of view of the binarized image generated in step S42 and the location data acquired in step S44 is performed. When the lidar 22 is mounted at a location different from the locations of the plurality of cameras 20, the correction resolves the displacement between the plurality of pieces of acquired location data and the location of the bounding box due to the difference in the attachment location between the lidar 22 and each of the cameras 20, and accurately removes the noise data from the plurality of pieces of location data.

In an example embodiment, the plurality of cameras 20 are set on the outer periphery of the marine vessel 1. With this arrangement, it is possible to obtain images covering the entire circumference of the marine vessel 1 when creating the bounding box, and thus, it is possible to accurately remove noise data from the plurality of pieces of location data acquired by the lidar 22 without depending on the detected direction.

Also, in an example embodiment, the plurality of cameras 20 are set at different locations on the marine vessel 1. Accordingly, by superimposing images captured by the respective cameras 20, it is possible to obtain an image in which any blocking object such as a portion of the marine vessel 1 does not appear, and thus, it is possible to accurately create a bounding box. As a result, noise data can be accurately removed from the plurality of pieces of location data acquired by the lidar 22.

Further, in an example embodiment, a portion of the marine vessel 1 appears in images generated by the cameras 20 so that an understanding of the sense of depth can be facilitated in images obtained on the sea where a sense of distance is difficult to recognize.

In an example embodiment, the distance measuring sensor is the lidar 22, and thus, the obstacle detection accuracy based on the location data of objects detected by the lidar 22 can be increased.

While example embodiments of the present invention have been described above, it is to be understood that variations and modifications will be apparent to those skilled in the art without departing from the scope and spirit of the present invention. The scope of the present invention, therefore, is to be determined solely by the following claims.

For example, a bounding box may be created in step S43 without the binarization process having been performed in step S42. In this manner, the number of procedures in the obstacle detection process can be reduced, and the load of the obstacle detection process can be reduced.

Also, in an example embodiment, the distance measuring sensor that detects an object in the obstacle detection process in FIG. 4 may be the radar 21. With this arrangement, the obstacle detection accuracy based on the location data of the objects detected by the radar 21 can be increased.

Further, in an example embodiment, the plurality of cameras 20 may be cameras having different angles of view. Here, a camera that captures images with a narrow angle of view can clearly capture images of relatively distant objects. On the other hand, a camera that captures images with a wide angle of view can cover a wide region in one image. By using these cameras in combination, it is possible to obtain an image with a wide angle of view and an image with a narrow angle of view as images to be used in creating a bounding box. As a result, it is possible to remove noise data detected at a relatively remote place from the plurality of pieces of location data acquired by the lidar 22 without depending on the detected direction.

Also, in an example embodiment, in the configuration in which the lidar 22 is used as the distance measuring sensor, a piece or pieces of location data each including height information indicating a height equal to or greater than a predetermined height among the plurality of pieces of location data may be determined to be noise data, and the piece or pieces of location data may be processed so as not to be used in obstacle determination. In an example embodiment, an object on the sea that hinders the vessel's navigation is regarded as an obstacle. However, an object far above the sea surface does not interfere with marine navigation, and therefore, there is no need to detect the object. In view of this, it is desirable to exclude the location data of such an object from the targets to be subjected to obstacle determination. Therefore, in an example embodiment, a piece or pieces of location data each including height information indicating a height equal to or greater than a predetermined height among the plurality of pieces of location data are determined to be noise data, and the piece or pieces of location data are not used in obstacle determination. Thus, it is possible to reduce the number of pieces of location data to be used in obstacle determination, and reduce the load of the process of obstacle detection.

Further, in an example embodiment, in a case where the number of pieces of location data included in the region of the bounding box 27 is equal to or larger than a threshold, the region indicated by the pieces of location data may be determined to be the region of an obstacle. With this arrangement, in a case where the bounding box 27 is created at an unintended location, it is possible to prevent the region around the bounding box 27 from being erroneously determined to be the region of an obstacle.

Furthermore, in an example embodiment, as the distance from the marine vessel 1 increases, a smaller value may be used as the threshold. Here, the bounding box tends to become smaller as the distance from the marine vessel 1 increases. Thus, it is possible to increase the obstacle detection accuracy by controlling the determination criteria in accordance with the distance from the marine vessel 1.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vessel steering system comprising:
a sensor to acquire location data of an object;
a camera to capture surroundings of the marine vessel; and
a controller configured or programmed to detect an obstacle around the marine vessel based on a bounding box created from an image generated by the camera and based on a plurality of pieces of location data acquired by the sensor.

2. The vessel steering system according to claim 1, wherein the controller is configured or programmed to detect the obstacle based on a subset of the plurality of pieces of location data acquired by the sensor, the subset falling within a region of the bounding box.

3. The vessel steering system according to claim 1, wherein
the location data includes height information; and
in detecting the obstacle, the controller is configured or programmed to not use a piece or pieces of location data each including height information having a height equal to or greater than a predetermined height among the plurality of pieces of location data acquired by the sensor.

4. The vessel steering system according to claim 1, wherein
the camera is located at a position different from the sensor; and
the controller is configured or programmed to perform a positioning correction between an angle of view of the image generated by the camera and the location data acquired by the sensor.

5. The vessel steering system according to claim 1, wherein the camera includes a plurality of camera located on an outer periphery of the marine vessel.

6. The vessel steering system according to claim 1, wherein the camera includes a plurality of cameras located at different positions on the marine vessel.

7. The vessel steering system according to claim 1, wherein the camera includes a plurality of cameras each having a different angle of view.

8. The vessel steering system according to claim 1, wherein the camera is located so that a portion of the marine vessel appears in the generated image.

9. The vessel steering system according to claim 1, wherein in a case where a number of pieces of location data included in a region of the bounding box is equal to or larger than a threshold, the controller is configured or programmed to determine a region indicated by the pieces of location data to be a region of the obstacle.

10. The vessel steering system according to claim 9, wherein the threshold decreases as a distance from the marine vessel increases.

11. The vessel steering system according to claim 1, wherein the sensor measures location data of an object using a LiDAR-based technology.

12. The vessel steering system according to claim 1, wherein the sensor is a radar sensor.

13. The vessel steering system according to claim 1, wherein the controller is configured or programmed to perform an edge detection process on the image generated by the camera to generate the bounding box.

14. The vessel steering system according to claim 1, wherein the controller is configured or programmed to perform a contour detection process on the image generated by the camera to generate the bounding box.

15. A steering control method for a marine vessel including a camera and a sensor to acquire location data of an object, the steering control method comprising:
detecting an obstacle around the marine vessel based on a bounding box created from an image generated by the camera and based on a plurality of pieces of location data acquired by the sensor.
